(19) United States
(12) Patent Application Publication
(10) Pub. No.: US 2011/0191801 A1
(43) Pub. Date: Aug. 4, 2011

(54) System and methods for switching between two or more media streams

(76) Inventor: Jawanth Vytheeswaran, Plano, TX (US)

(21) Appl. No.: 12/931,517

(22) Filed: Feb. 3, 2011

Related U.S. Application Data
(60) Provisional application No. 61/301,447, filed on Feb. 4, 2010.

(51) Int. Cl. H04N 7/10

(52) U.S. Cl. 725/34; 725/32; 725/36

(57) ABSTRACT

Provided herein are systems and related methods for switching to an alternate audio/video signal or stream during advertisement breaks in a media provider's programming signal, or other events detected by the system. The system for switching to alternate stream may include a system to detect an event and switch to an alternate signal or stream. Exemplary components may comprise a client based cue generation system, a server based cue generation system, an advertisement cue handling and stat recorder element, viewer dataminer and categorizer, an alternate signal selector, a personal data backup process and a server based controller and alternate signal storage server.

### PRIORITY CLAIM

The present disclosure claims priority to, and is a non-provisional conversion of, U.S. Provisional Patent Application No. 61/301,447, filed Feb. 4, 2010, all of which is herein incorporated by reference in its entirety for all purposes.

### TECHNICAL FIELD

The present invention relates generally to video processing and more specifically it relates to a system for switching between media streams, while viewing broadcast media programming, in response to cues generated by the system. More specifically, the disclosed principles relate to cue generation processes for triggering the switch to an alternate stream, identifying viewer characteristics from viewer's personal data backup system, and selecting alternative streams based on those characteristics.

### BACKGROUND OF THE INVENTION

In existing media broadcast systems, advertisements can be considered to be an alternate stream, different from the main program. Advertisement streams are usually selected and then inserted into the stream during advertisement breaks. Generally, the insertion of an advertisement is done either at some centralized point by local broadcasters, or locally at the viewer's location by set top boxes. In existing systems, the insertion is controlled by different forms of explicit cues or indicators in the program media stream. These cues can take the form of audibles, or in the case of MPEG streams, can be cue packets. These cues signal advertisement breaks.

For example, in broadcast programming, the television programming stream includes cue tones, placed at specific points in the media program stream, typically by content providers. These cue tones are then detected by local broadcasters, interpreted as advertisement breaks and then advertisements are inserted. These cue tones may also indicate the duration of the advertisement break. However, in all such approaches, cue tones or other types of cues are embedded in the media provider's audio/video communication signal for the express purposes discussed above. Thus, for obvious reasons, media providers not readily provide entities outside of the traditional advertisers and local broadcasters a means to detect such embedded cues, since to do so could lead to a means for viewers to bypass intended advertisements.

Based on the existing advertisement cue systems discussed above, the Applicant has recognized that existing media systems do not provide viewers with sufficient automated capability or control to view alternate streams that may be of interest to them during advertisement breaks, or even during other events. Existing systems require the viewers to switch manually to an alternate stream, for example selecting another channel or source, if they so desire, and then return back to the main program after the advertisement break. The capability to automate the switch back and forth between main programming and alternate streams would be very valuable to viewers. Furthermore, it would be a great improvement in art to match such alternate streams to a viewer's personal data. Such data would be very valuable to advertisers and viewers alike. Generally speaking, existing systems may gather and store data about viewer's characteristics based on their viewing patterns, including requesting information from the viewer. However, the Applicant has recognized that providing a backup storage for viewer's personal data stored on other systems such as their personal computer would lead to a more richer and comprehensive view of a viewer's preferences without transmitting such data to the outside world. The present invention addresses these deficiencies and others found in the prior art.

### BRIEF SUMMARY OF THE INVENTION

The invention generally relates to a video processing which includes a system to generate a cue, a system to receive a cue and switch to alternate stream on receipt of the cue, which in varying embodiments comprises of a client based cue generation system, a server based cue generation system, a cue handling and stat recorder element, an alternate stream collector and categorizer, viewer dataminer and categorizer, an alternate stream selector, a personal data backup process and a server-based controller and stream server. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the invention is to provide a system for switching to an alternate audio/video communication signal at anytime during receipt of a media providers audio/video signal, including but not limited to advertisement breaks on a media provider's audio/video signal.

Another object of the invention is to provide a system for switching to an alternate audio/video communcation signal during advertisement breaks that detects the beginning and end of commercial breaks and resumption of main programming after advertisement breaks.

Another object of the invention is to provide a system for switching to an alternate audio/video communcation signal during advertisement breaks that can receive a cue from a server, on which a cue generating system detects the beginning and end of commercial breaks and resumption of main programming after advertisement breaks.

Another object of the invention is to provide a system for switching to an alternate audio/video communcation signal during advertisement breaks that can gather, store and categorize audio/video signals, which can include alternative advertisements, that can be shown as an alternate audio/video signal.

Another object of the invention is to provide a system for switching to an alternate audio/video communcation signal during advertisement breaks that provides backup storage and a process to backup and restore viewer's personal computer data on the backup storage.

Another object of the invention is to provide a system for switching to an alternate audio/video communcation signal during advertisement breaks that analyzes the personal computer data of the user to categorize viewer's preferences.

Another object of the invention is to provide a system for switching to an alternate audio/video communcation signal during advertisement breaks that selects an alternate audio/video signal based on categorization of the viewer's preferences.

Another object of the invention is to provide a system for switching to an alternate audio/video communcation signal during advertisement breaks that can receive a cue from a server, that detects the beginning and end of commercial breaks and resumption of main programming, and starts or stops the alternate audio/video signal based on the cue.

Another object of the invention is to provide a system for switching to an alternate audio/video communcation signal during advertisement breaks that can receive a cue from a server, that detects the beginning and end of commercial breaks and resumption of main programming, and starts or stops the alternate audio/video signal based on the cue, collects data about the alternate audio/video signal shown and optionally sends the collected data to an advertisement server.

Based on the above, in one aspect, systems for switching to an alternate audio/video communcation signal in response to an event, such as during advertisements transmitted on a media provider's audio/video communication signal, are discussed herein. In one embodiment, such a system may comprise a cue generation system configured to receive a raw audio/video signal decoded from a data signal transmitted from a media provider. The detection system could also be further configured to detect a start or end of one or more advertisements from the raw audio/video signal decoded from the media provider's audio/video signal, or simply the start or end of some other event either from the media provider's signal or from another source. The overall system may also comprise an alternative signal selector configured to select an alternative audio/video signal in response to the cue from the cue generation system when the start of the event is detected. Furthermore, the overall system may also comprise an alternative signal handling element configured to do multiple tasks. In response to a cue from the cue generation system when the alternative signal is selected, the alternative signal handling element can cause the selected alternative audio/video signal to be transmitted to a viewer in lieu of the media provider's signal, for example for the duration of a commercial break. Also, in response to a cue from the cue generation system when the end of an event is detected, the alternative cue signal handling element can cause transmission of the selected alternative audio/video signal to the viewer to cease such that the media provider's audio/video signal is permitted to be transmitted to the viewer.

In another aspect, methods for switching to an alternate audio/video communcation signal in response to detected events, such as during advertisements transmitted on a media provider's audio/video communication signal, are also discussed herein. In one embodiment, such a method may comprise receiving a raw audio/video signal decoded from a data signal transmitted from a media provider, and then detecting, with a cue generation module installed on one or more tangible devices, a start or end of one or more events, such as advertisements in the raw audio/video signal decoded from the media provider's audio/video signal. Such a method may also comprise receiving, at an alternative signal handling element installed on one or more tangible devices, a cue from the cue generation system when the event is detected. Thus, such an exemplary method may comprise selecting an alternative audio/video signal in response to receiving the cue. Furthermore, an exemplary method may comprise transmitting the selected alternative audio/video signal to the viewer in lieu of the media provider's signal in response to the cue when the alternative signal is selected, as well as terminating any transmission of the selected alternative audio/video signal to the viewer in response to a cue or other notification from the cue generation system when the end of an event, such as the end of one or more advertisements, is detected, such that the media provider's audio/video signal is permitted to be transmitted to the viewer.

There has thus been outlined, rather broadly, some of the features of the invention in order that the detailed description thereof may be better understood, and in order that the present contribution to the art may be better appreciated. There are additional features of the invention that will be described hereinafter. Such other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating one embodiment of a system for switching to an alternate audio/video communcation signal during advertisements in the audio/video signal transmitted by a media provider, in accordance with the present invention.

FIG. 2 is a block diagram illustrating an exemplary embodiment of a client based ad detection and cue system, which may be similar to the client based ad detection and cue system illustrated in FIG. 1.

FIG. 3 is a block diagram illustrating an exemplary embodiment of a server based ad detection and cue system, which may be similar to the server based ad detection and cue system illustrated in FIG. 1.

FIG. 4 is a block diagram illustrating a basic process for server based ad detection and cue system, such as the system illustrated in FIG. 3.

FIG. 5 is a block diagram illustrating an optional process for server based ad detection and cue system employing human ad detectors.

FIG. 6 is a block diagram illustrating an exemplary process for switching to an alternate audio/video signal in accordance with the disclosed principles, including employing an Ad Cue Handling and Stat Recorder such the recorder illustrated in FIG. 1.

FIG. 7 is a flowchart illustrating an exemplary embodiment of the overall operation of a system or method for switching to an alternate audio/video communcation signal during an advertisement break in the audio/video signal transmitted by a media provider.

### DETAILED DESCRIPTION OF THE INVENTION

### A. Overview

Turning now descriptively to the drawings, in which similar reference characters denote similar elements throughout the several views, the figures illustrate a system to switch to and from an alternate audio/video signal, anytime during the reception, including but not limited to, the duration of the detected advertisement break. In various exemplary embodiments, such a system comprises of a client based advertisement detection and cue system, a server based ad detection and cue system, an advertisement cue handling and stat recorder element, an advertisement collector and categorizer, viewer dataminer and categorizer, an advertisement selector, a personal data backup process and a Server based controller and advertisement server.

### B. A System to Detect Advertisement Breaks and Switch to Alternate Stream

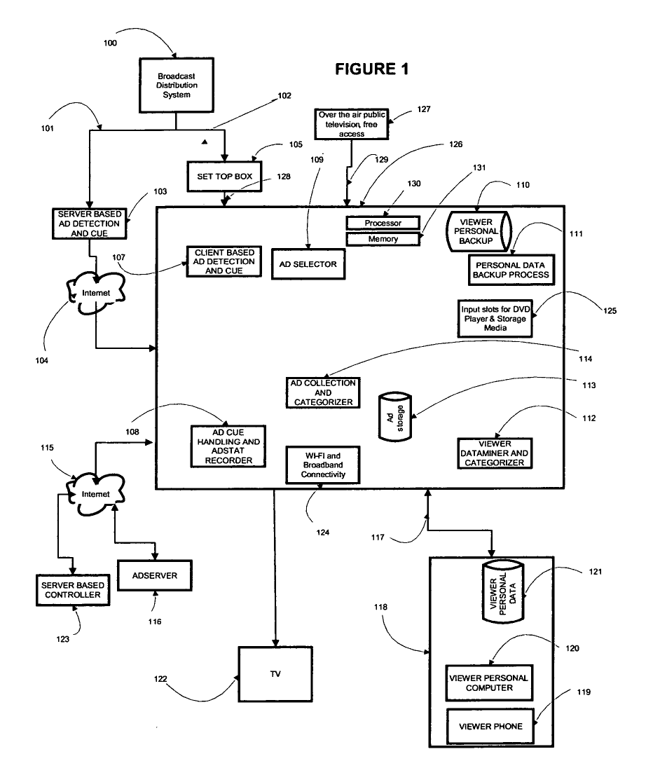

FIG. 1 is a block diagram of a system to detect advertisement breaks and switch to alternate viewing for the duration of break, in accordance with one embodiment of the present invention. In such embodiments, the cue generation system analyzes the content on the media stream and generates a cue for example on detecting advertisement breaks and resumption of main programming, or on detecting that the audio/video signal corresponds to an emergency broadcast stream, or on detecting that the audio/video signal is part of the users navigation of set top box and such;, but in other embodiments the cue generation system generates a cue to signal the displaying of the alternate media stream in response to other events that may or may not occur on the incoming media provider's signal. Such events, for example, include but not limited to, receipt of an alarm from a timer, recognition of other user defined events, such as receipt of a phone call, emails, text messages or such. In order to detect such events, the viewer is allowed to configure the system. These events may also be generated by external devices, such as personal computers connected to the system. Such events can be the receipt of a phone call, a text message, an email or an urgent message from a friend, or a clock timer, for example. In order for detecting such events, interfaces will be provided to the server system. Another event example is a high priority announcement, for example, weather warning messages, or emergency broadcast system, on the media provider's stream. When such events are detected, a cue pertaining to said event is generated.

One special example of event is when viewer has configured element 126 to bypass the alternate stream methods discussed in this invention altogether. When such a configuration is detected, the input stream from media provider signal is passed directly to the viewer by the invention. However, although the present invention is not so limited, for simplicity of discussion cue generation events discussed with reference to FIG. 1 and its related figures are based on analyzing the content of the input audio/video signals.

The main element of the invention is shown in element 126, which may be typically embodied in a client based (i.e., viewer) unit. The inputs to element 126 comprise of input audio/video signals from set top box 105 and comprise other sub-elements, discussed below. Element 126 of the invention is also referred to as the client system and exists in a viewer's home. Set top box 105 exists in viewer homes or viewing location and receives television programming in the form of audio/video signals from media providers 100. Media provider distribution 100 includes, but not limited to, for example, cable, dish, fiber-optic, internet TV or any medium. The output from 105 is fed through cables and can be any video standard. For example, the inputs (shown as element 128) to unit 126 can be delivered using common connectors including but not limited to HDMI, component, RCA, composite, s-video and other standards.

In an alternate embodiment, the input to main unit 126 also comprises of off-the-air digital television programming 127. Throughout this disclosure, although television and other media programming is used to describe the input to the main unit 126, it should be noted that any type of input to the main unit 126 may provide the original media audio/video signal, including Internet data stream and the like. When the input is from such digital TV programming 127, additional decompression of video signals, for example decompression from MPEG4 format, is executed inside elements in unit 126. Unit 126 also comprises of connections through the internet to servers 116, 123. It also comprises of connection to a users computer system 118. Unit 126 also comprises a processor 130 and memory 131. The processes described in the elements that are inside unit 126 can be stored and executed using processor 130 and memory 131. All the sub-elements of the invention inside unit 126 can be implemented with software and hardware processes using the processor 130 and memory 131.

### C. Client-Based Advertisement Detection and Cue System

A client-based advertisement detection and cue system is shown as 107 in FIG. 1. It comprises procedures which can be executed using processor 130 and memory 131. Client based advertisement detection and cue element 107 analyzes the input media stream 128 of set top box 105. Element 107, which is embodied in hardware and software installed in main unit 126, comprises sub-elements, for example video cards, that implement known methods that can process the input stream 128 and convert it to a known digital representations of video and audio, for example, digital bit sequence or frames, representing, but not limited to, color, intensities and the like.

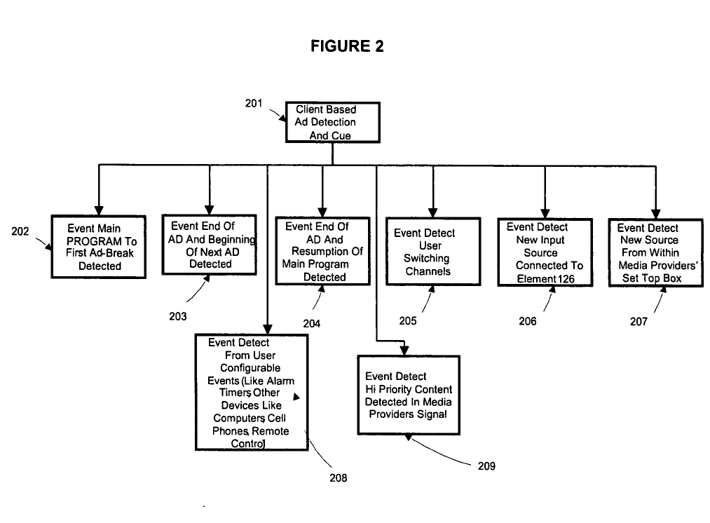

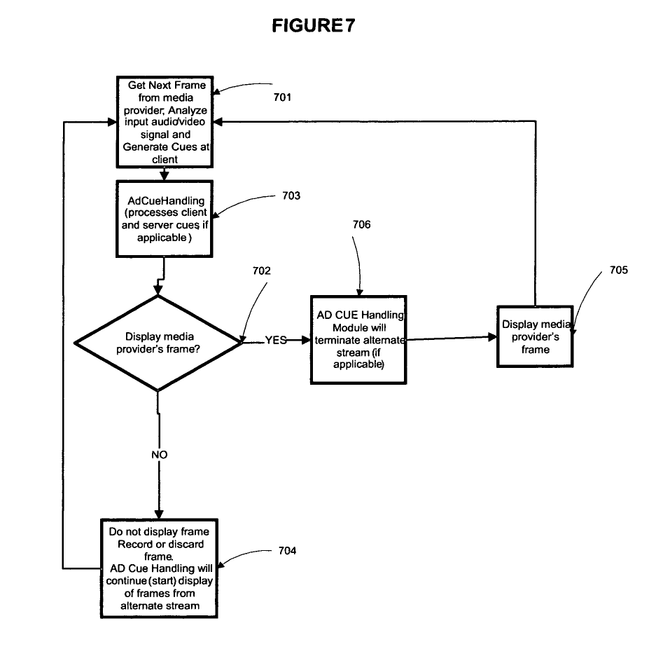

FIG. 7 shows a flowchart of the overall flow which corresponds to one embodiment of the element 107. In Step 701 it starts with reading a frame of input from media providers stream 128. It analyzes the input frame and implements procedures to detect events pertaining to FIG. 2, which is described in detail in later paragraphs. In step 703 it passes the cues to ad-cue handling element 108 which processes the cues. In step 702 it receives indication from adcue handling element whether to display the media provider's stream or the alternate stream. If the decision is YES, the media provider's stream frame is displayed, and the adcue handling element will stop the display of alternate stream, if it was being displayed. If the decision is NO, it records or discards the media provider frame and the adcue handling element will continue or start the display of the alternate stream frame. Importantly, the disclosed principles do not make use of the conventional “cues” embedded in typical media provider's transmitted audio/video signals, which as described above are provided in such signals for advertisement insertion at the local network level, or viewer's location etc. Instead, the disclosed principles provide for the detection of the start or end of one or more advertisements in a media provider's signal by detecting the transition from programming to advertisement (whether the advertisement is inserted by a local network or not) and back to programming without conventionally used embedded cues. As discussed herein, such cue-free detection may be accomplished with automated or even human means by analyzing the audio video signal of the media stream provider.

FIG. 2 explains one aspect of the sub-functions of the client based ad detection and cue element 107, which is to generate zero or more cues pertaining to events 202, 203, 204, 205, 206 207, 208 and 209 as and when each event occurs, and pass the notification to element 108. For example, one such sub-function of element 107 is to analyze input streams 128 and generate a notification event element 202 when element 107 detects the advertisement break in a audio/video stream. A second such sub-function of element 107 is to analyze input stream 128 and recognize the end of one advertisement and the beginning of the next advertisement, and generate a notification event element 203.

A third such sub-function of element 107 is to analyze input stream 128 and detect the end of the advertisement break and thus the resumption of main programming, and generate a notification event 204. A fourth sub-function of element 107 is to detect a switching of channel at the set top box by the viewer, and generate a notification event 205. A fifth sub-function of element 107 is to detect a switch to a different input source by the viewer, and generate a notification event element 206. A sixth sub-function of the element 107 is to detect a switch to a different source originating from within the set top box by the viewer, for example a digital video recorder, and generate a notification event element 207. Additional sub-function to detect other events may be added to element 107 and is not limited to the examples described.

The methods used by element 107 to detect can be specified by the viewer on his/her behalf. It can be in the form of procedures executed by a processor, such as processor 130 and memory system 131. One example of a method for detection pertaining to events of elements 202, 203 and 204 is looking for a sequence of frames that have brightness below a threshold, in the input stream 128. Other methods, such as commonly available algorithms that analyze input frames and detect advertisement breaks probabilistically, can also be used. Element 107 may also use algorithms that use a pattern recognition system. Element 107 provides the user with an interface, such as element 120, to input such patterns and input the software logic for detection of advertisement breaks, detection of end of one advertisement and the beginning of the next advertisement, and detection of resumption of main programming.

The client based cue generation system comprises of detecting other events, such as but not limited to events mentioned in 208 and 209. Event 208 can be for example a user configurable event. Such events can be the receipt of a phone call, a text message, or an urgent message from a friend, or a clock timer, for example. In order for detecting such events, interfaces will be provided to the server system.

Another event example is event 209, that pertains to detecting a high priority announcement, for example, weather warning messages, or emergency broadcast system, on the media provider's stream. When such events are detected, a cue pertaining to said event is generated. One special example of event 208 is when viewer has configured element 126 to bypass the alternate stream methods discussed in this invention altogether. When such a configuration is detected, event 208 is generated. In such a case, the input stream from media provider signal is passed directly to the viewer by the invention.

One of the exemplary methods employing element 107 comprises the viewer, clicking one or more buttons on an input device, for example a remote control, while the viewer is detecting the events, and signaling the occurrence of the relevant event 202, 203 or 204. After the detection is done, element 107 passes to ad cue handling and adstat recorder 108 a notification of which event 202, 203 and 204 has occurred, and also passes identifiers to element 108 pertaining to the input stream 128, including but not limited to, the function that triggered the event, the broadcast network, type of set top box, type of receiver/tuner, type of video distribution system, for example Cable or satellite or off-the-air, channel watched and program being watched.

### D. Server Based Ad Detection and Cue Generation System.

In an alternative embodiment of the disclosed principles, a server based ad detection and cue system is shown as element 103 in FIG. 1. Such a system 103 comprises procedures which can be executed using a server computer system. Server based system 103 has a server based process that detects the beginning and end of commercial breaks, and resumption of main programming, and cues such detection to the client ad cue handling system 108 that receives such cues (which are distinguished from conventional embedded cues in media provider's signals) and starts or stops the alternate stream. As shown in FIG. 4, one embodiment of element 103 comprises of a set top box 401 affiliated with the server based system rather than a viewer based system, an over-the-air broadcast receiver tuner 402, an cue generation system 403, and a notification system 404. In such a server based embodiment of the disclosed principles, element 103 receives inputs from media provider distribution systems 100 in FIG. 1.

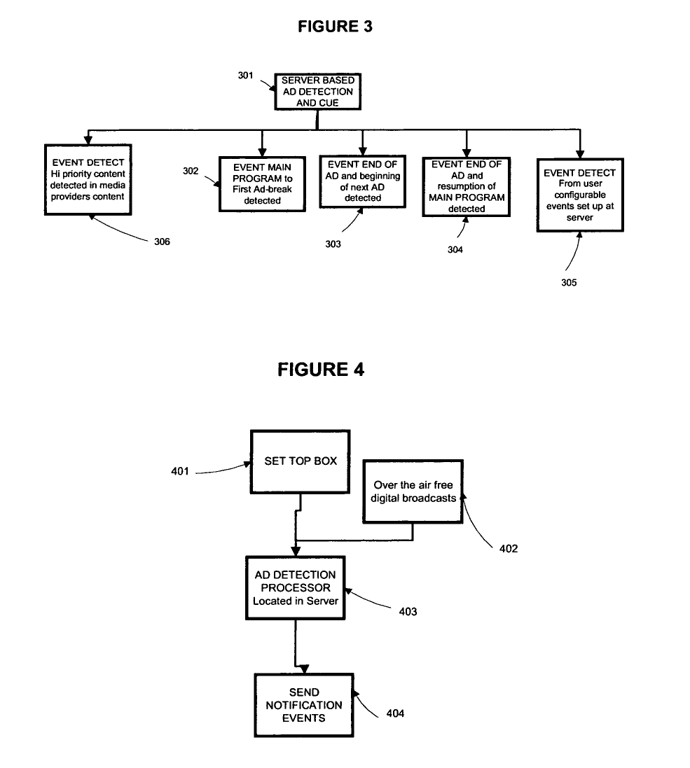

Turning briefly to FIG. 3, this figure explains one aspect of the function of element 404, which is to detect advertisement breaks and generate notification events 302, 303 and 304 as and when each event occurs, and pass the notification to element 108. Element 404 send notifications 302, 303 and 304 to element 108 using communication network 104, for example a private network, cellular network or the Internet. More specifically, element 404 uses exemplary processors and exemplary communication network and high speed internet to communicate to element 108 resident in client homes. The notification passed by element 404 comprises of identifiers that uniquely identify the event that occurred, 302, 303 or 304, identifiers pertaining to the input streams from elements 401 and 402, including but not limited to the broadcast network, type of set top box, type of receiver/tuner, type of video distribution network, for example Cable or satellite or off-the-air, channel watched and program being watched.

Looking at the exemplary functions of element 103 in further detail, one function of element 103 is to analyze input streams from elements 401 and 402, and generate a notification pertaining to event 302 when element 103 detects the advertisement break in a received media audio/video stream. A second function of element 103 is to analyze input streams from elements 401 and 402, and recognize the end of one advertisement and the beginning of the next, and generate a notification pertaining to event 303. A third function of the element 103 is to analyze input streams from elements 401 and 402 and detect resumption of main programming, and generate a notification pertaining to event 304.

The methods used by element 103 can be in the form of procedures executed by a server based computer. One example of a method used by element 103 for detection pertaining to events 302, 303 and 304 is looking for a sequence of frames that have brightness below a threshold in the input. Other methods that can also be used by element 103 include commonly available algorithms that analyze input frames and detect advertisement breaks probabilistically. Element 103 may also use algorithms that use a pattern recognition system to detect the above-described exemplary events.

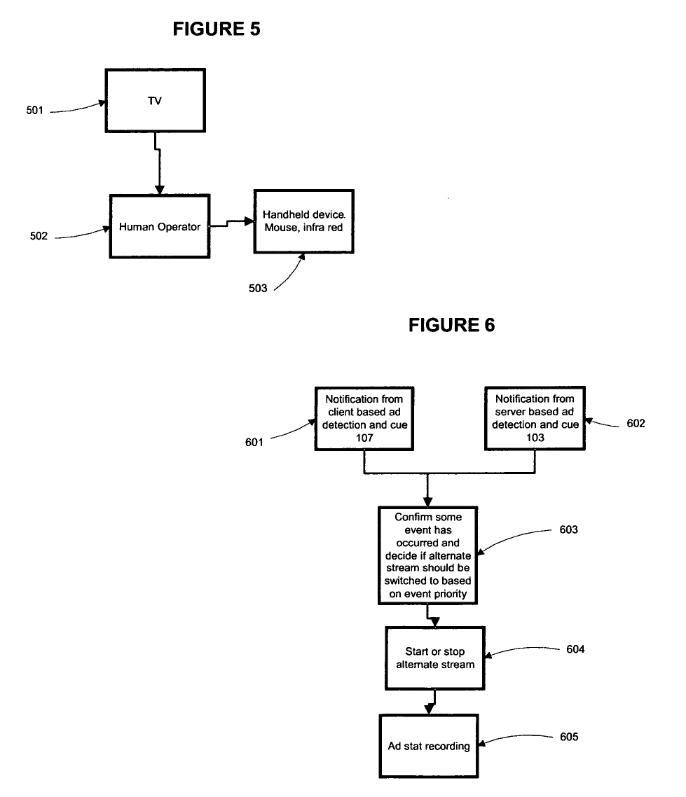

An alternative example of one of the methods element 103 uses for server based detection of advertisement breaks may comprise a human operator, as illustrated in FIG. 5. The human operator 502 may use an input device, for example a remote control, signaling events 302, 303 and 304. The human operator 502, for example, can be situated in front of a TV screen 501, which is connected to a set top box for elements 401 or 402, visually monitoring a program. Human operator 502 can visually identify, with very good accuracy and instantaneously, when watching a specific program that events 302, 303 or 304 has occurred. The operator 502, preferably immediately, presses an input device 503 that notifies element 404. The input device 503 can, for example resemble a mouse or other click device like a remote infra-red device. The device 503 may additionally have the capability to transmit immediately information identifying one of the events 302, 303, or 304, and the information used by element 404. The information passed by element 503 comprises of identifiers that uniquely identify the event that occurred, 302, 303 or 304, identifiers pertaining to the input streams from elements 401 and 402, including but not limited to the broadcast network, type of set top box, type of receiver/tuner, type of media distribution network, for example cable or satellite or off-the-air, channel watched and program being watched.

In addition to detecting advertisement related events, the server based cue generation system comprises of detecting other events, such as but not limited to events mentioned in 305 and 306. Event 305 can be for example an user configurable event. Such events can be the receipt of a phone call, a text message, or an urgent message from a friend, for example. In order for detecting such events, interfaces will be provided to the server system. Another event example is event 306, that pertains to detecting a high priority announcement, for example, weather warning messages, or emergency broadcast system, on the media provider's stream. When such events are detected, a cue pertaining to said event is generated. The user or viewer can configure such events on the server or it can be done on his/her behalf.

In this embodiment and in embodiments employing automated server based detection and notification, the server based systems work with the components within unit 126 to perform the disclosed principles. However, in alternate embodiments, the server based ad detection and cue generation system may not exist, such as the embodiments discussed above where all advertisement break detection and cue generation is performed locally within unit 126.

### E. Ad Cue Handling and Stat Recorder Element

The ad cue handling and stat recorder is shown as element 108 in FIG. 1. It receives cues, and in response to such cues, starts and stops the alternate audio/video signal or stream. It collects data about the alternate streams that are shown to the viewer in place of the media provider's advertisements, and sends it to an ad server 116. Element 108, the ad cue handling and stat recorder element, receives notification about ad detection events, and switches the viewer to an alternate stream, which can include alternative advertisements (e.g., locally or demographically based on the viewer), or even personal messages provided by persons known by the viewer.

Element 108 receives notification from one or both of elements 107 and 103, depending on the embodiment of the disclosed principles being implemented. In one embodiment of the invention, as shown in FIG. 1, both elements 103 and 107, send notifications. Element 108 uses one or both of these notifications received independently and separately from elements 107 and 103 to decide conclusively if any of the events, has occurred. Depending of which event has occurred, elements 108 executes the appropriate command in accordance with the embodiments discussed above. Element 108 also implements a prioritization between these events which can be configured. The events shown in FIG. 2 and FIG. 3 are examples of events that are handled by Element 108. Element 108 prioritizes between these events and the result of handling these events is either to start display or stop display of the alternate stream. The alternate stream frame or media providers frame is then sent to output 132, which is then displayed on the viewer's TV 122. The resulting action for each event listed shown in FIGS. 2 and 3 is configurable and programmable. Element 108 can thus take into account and prioritize among a combination of several factors in deciding whether the media providers stream or the alternate stream.

Such factors include for example such as whether it is acceptable to switch away from input media providers stream, whether media providers stream has switched to an advertisement, whether the event is an urgent event and such. Some examples of events that cause the media stream to be displayed are Events 204, 209, 205 and 207. Examples of events that can cause alternate stream to be displayed are 202, 203 and 208. FIG. 6 shows one aspect of the function of element 108. More specifically, FIG. 6 shows some exemplary sub-components of element 108, which chooses between the two sources of notifications from elements 107 and 108. As shown in FIG. 6, element 108 can be programmed to use any desired procedure in element 603 to make a confirmation of which event has occurred.

One example of such a procedure would be to use notification 601 from element 107 if a connection from element 103 to unit 126 is down or otherwise unavailable. Another example is to conclude a specific event has occurred only if notifications from both elements 103 and 107 concur that said event has occurred, with notifications from the respective elements occurring within a very short interval, typically within milliseconds, of each other. Another example is to give priority to a specific notification event, for example, resumption of main programming event from element 601, over any notification from server based element 103. One method, preferably, is to use the notification from 601 always over 602.

If the event confirmed at step 603 is that of resumption of main programming, then element 108 stops the providing of the alternate stream, and element 107 resumes output of input stream 128. If the event confirmed at step 603 is not that of resumption of main programming, then element 108 starts or continues to display the alternate stream selected by ad selector 109. Element 108 continues to display the alternate stream until a notification is received from element 107 that corresponds to resumption of main programming. Element 108 also keeps data pertaining to alternate streams, including but not limited to, which streams have been played, how many times they have been played, length of time played, did an event in element 603 occur before the end of the playing of an alternate stream, etc. Element 108 may also optionally transfer data so collected to a server based controller 123, which corresponds with ad server 116. Thus, server based controller 123 can be used in conjunction with ad selector 108, and based at least in part on the data provided to it by element 108, to determine which alternative stream should be provided to the viewer.

An aspect of unit 126 is that the main stream 128 provided by the media providers is displayed in output stream 132 when element 108 is not displaying the alternate stream. In one embodiment, element 126 discards the main media provider stream 128 when the alternate stream is being displayed by element 108. In another embodiment, element 126 can store the main stream 128 in a file system storage during the period element 108 is displaying the alternate stream. In another embodiment, on receiving a notification of a detection of an advertisement break or of the detection of the end of one break and the beginning of the next advertisement, element 108 displays the alternate stream for a certain time interval, and then switches to the input stream 128, even without receiving any further notifications from elements 107 or 103. In such an embodiment, element 108 will still stop playing the alternate stream, if it receives a notification of the resumption of main programming from step 603, while element 108 is displaying alternate stream.

### F. Ad Collector and Categorizer

The ad collector and categorizer is shown as element 114 in FIG. 1. It gathers, stores and categorizes video streams or advertisements that can be shown as an alternate stream. The categories are the same as the ones chosen by the viewer dataminer and categorizer 112, which is discussed in further detail below. Element 114 is a system for collecting and categorizing advertisements. Element 114 comprises various input methods for collecting advertisements. For example, element 125 shows one method of collecting advertisements by comprising input slots 125 for media players such as flash drives, DVD drives, and digital media players. Element 114 can also gather advertisements streamed from ad server 116 over the communication network and/or the interne, shown as network 115. The advertisements collected by element 114 can be in any file storage format. The advertisements collected by element 114 can also be played by streaming players. Examples of advertisements collected and categorized can also include private or personal messages from individuals.

Element 114 is also provided with information on categorizing the advertisements so collected. The categories include but are not limited to location, age, gender, subject (for example, cars), audience rating (for example, mature, PG-13), and the like. Element 114 stores the advertisements in Ad storage element 113. Element 114 may index the advertisements for easy and fast access. The advertisements mentioned here are also referred to as “alternate streams” in the descriptions of the invention provided herein.

### G. Viewer Dataminer and Categorizer

Viewer dataminer and categorizer 112 analyzes the personal computer data of the viewer, and categorizes the viewer's preferences, using the same categories used by element 114. Viewer data miner and categorizer 112 implements methods to analyze data in the data storage element 110, which stores viewer personal data. The methods include, for example, but not limited to, implementing common data mining algorithms that can infer certain characteristics of the data that are stored. Such characteristics can be used to infer certain viewer preferences. For example, the personal data in element 110 may contain the browsing habits of the viewer. Such information is used to prioritize the viewer preferences into categories that can be used by element ad selector 109. For example, if the viewer data, for example, their most recent internet searches inferred from cookies files, contains references to the topic of cars, the viewer preference for cars is inferred. The category “cars” becomes a relevant category for the viewer. Other example may include searching the viewer's recent email files. Ad selector 109 then uses this information to select advertisements pertaining to that category from the ad storage 113. Element 112 can also keep statistical scores of how many times an alternate stream (e.g., alternate advertisement) was displayed, for example, and implement common algorithms for such purposes. Additionally, element 112 is notified by element 111 if a new backup of the viewer's personal data has been completed. Element 112 can optionally send information about the data mined to an external server. Further, the user is allowed to specify what data, if any, that can be sent to server.

### H. Ad Selector

The ad selector 109 selects an alternate stream based on a categorization of the viewer's preferences. Ad selector 109 is a system for selecting an alternative stream to show the viewer. The alternate streams are also referred to in the description of the invention as advertisements. The stream files are stored in 113. Element 109 refers to the element 112 to find the prioritized list of categories into which the viewers preferences have been categorized. Element 109 can use any algorithm to select the next ad for display. For example, one method can be to select an ad that has the same category classification as the viewer's location. Element 109 provides the ad so selected to cue handling and adstat recorder element 108.

### I. Personal Data Backup Process

This is shown in FIG. 1 as elements 111, personal data backup process and 110, viewer personal backup storage. Element 110 provides backup storage and 111 provides a process to backup and restore viewer's personal computer data on the backup storage. Personal data includes any data the user wishes to backup, for e.g., disk drives that the user has, for example on their personal computers, thumb drives and such. Element 111 personal data backup process implements methods to backup personal data of the user. Element 112 communicates with 118, a user home computer system, using element 124, which can be, but not limited to personal broadband, Wi-Fi, local area network, home network, and such. Element 111 stores the files in 110 viewer personal backup storage. The storage that is backed up in 110 can also comprise of storage from other devices such as phones, element 119.

Element 120 is a home computer device, which can be used to control element 111. Element 111 can also be controlled by 123, a server based controller computer. Element 111 can also backup a viewers personal data files 121, where 121 can be resident on a computer or server outside the home of the viewer. Element 111 can be controlled by viewer's computer 118. Element 111 notifies Element 112 when a new backup process has just completed.

### J. Server Based Controller and Ad Server

The elements 123 and 116 are elements that exist in a server. They are used to communicate and send files and administrative information such as for billing. They can also act as interfaces to access the procedures in client system 126. Element 116 sends alternate streams to Element 114, which are used by element 108. Element 126 also comprises of Element 118, a computer with inputs that is resident in a viewers home. This element may be used to input viewer preferences and to control elements of system 126. Element 118 also communicates with 126 to retrieve ad stats, as stored by element 108.

The invention also comprises a server based controller 123 of element 126. It connects to the element 126, for example, through the internet. The invention also comprises element 116, ad server. The ad server uses communication network, for example, through internet and interacts with element 114 to send ad files. The ad files may be categorized and have the category information along with the file.

### K. Operation of Preferred Embodiment

In the typical mode of operation of the elements 103, 107, 108 and 109 with the embodiment shown in FIG. 1, 126 is connected to a set top box 105 and the viewer is displayed the contents of that stream on TV, element 122, for example channel 795 on a direct to home set top box. When the client based ad detection system 107 senses a transition to an advertisement in the input media stream, for example Ad1, the ad cue handling element 108 is notified. Element 107 then stops displaying the next frame from the input stream. Element 103 also generates a notification. The ad cue handling system 108, immediately starts playing the next file of the alternate stream, for example an advertisement, selected by the ad selector element 109.

As FIG. 7 shows, Element 107 continues to get the next frame from stream 128 and analyze the frame, but does not send it to display. As soon as it detects a transition to another ad, for example Ad2 in the input media stream, 107 notifies 108. Element 103 also generates a notification. Element 108 processes these notifications and decides to continues to play an alternate stream when it receives the notification about transition to another ad, Ad2. Element 107 then loops and the operation repeats.

When element 107 eventually detects a frame or events that causes 107 to decide to resume display of frame from input media stream, it starts sending the input frame from 128 to display, and sends notification to Element 108 that a resumption to main programming has occurred. Element 103 also sends a notification that resumption to main programming has occurred. Element 108 processes these notifications and immediately stops playing the alternate stream. It also makes some statistical data recording in local storage and sends it optionally to server element 123.

When the user switches to a source other than a broadcast stream for example, a digital video recorder, the client ad detection and cue process element 107, senses that and generates a resumption of main programming notification, and starts sending the input frame from 128 to display, and sends notification to Element 108 that a resumption to main programming has occurred. Element 108 immediately stops displaying the alternate stream and records statistical data.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. A system installed on one or more tangible devices for switching to an alternate audio/video communcation signal during transmission of a media provider's audio/video communication signal, the system comprising:
a cue generation configured to receive a raw audio/video signal decoded from a data signal transmitted from a media provider, the cue generation system further configured to detect a start or end of one or more cue generation events and generate a cue based on said detection;
an alternative signal selecting system configured to select an alternative audio/video signal in response to the cue generated by the cue generation system;
an alternative signal handling element configured to:
in response to the generated cue from the cue generation system, cause the selected alternative audio/video signal to be transmitted to a viewer in lieu of the media provider's signal, or
in response to a notification from the cue generation system based on an end of the event detected, or another event is detected that requires resumption of display of the raw audio/video signal from the provider, cause transmission of the selected alternative audio/video signal to the viewer to cease such that the raw audio/video signal decoded from the media provider's audio/video signal is permitted to be transmitted to the viewer.

2. A system in accordance with claim 1, wherein the cue generation system comprises a locally based system at the location of the viewer.

3. A system in accordance with claim 1, wherein the cue generation system comprises a server based system connected to the location of the viewer via a public data network.

4. A system in accordance with claim 3, wherein the cue generation system further comprises one or more human operators to detect the start or end of an event.

5. A system in accordance with claim 1, wherein the event is an advertisement break.

6. A system in accordance with claim 1, further comprising personal data storage for storing personal data regarding the viewer taken from the viewer's personal device or devices.

7. A system in accordance with claim 6, further comprising an alternative signal collector and categorizer associated with the personal data storage, and configured to select one or more alternative signals based on the personal data regarding the viewer.

8. A system in accordance with claim 6, wherein the alternative audio/video signal is an alternative advertisement selected based on viewer personal data.

9. A system in accordance with claim 1, wherein the alternative signal is transmitted from a server across a public data network before display to the viewer.

10. A system in accordance with claim 9, further comprising a buffer configured to temporarily hold data provided in the transmitted alternative signal until the alternative signal is displayed to the viewer.

11. A system in accordance with claim 1, wherein the alternative signal is provided to the system via disc or other storage media.

12. A system in accordance with claim 1, wherein the media provider's signal is selected from the group consisting of over-the-air broadcast signals, satellite dish signals, internet streaming data and cable signals.

13. A method for switching to an alternate audio/video communcation signal during transmission of a media provider's audio/video communication signal, the method comprising:
receiving a raw audio/video signal decoded from a data signal transmitted from a media provider;
detecting, with a cue generation system, a start or end of an event, and generating a cue based on said detecting;
receiving, at an alternate signal selecting element installed on one or more tangible devices at viewer's premises, the cue generated by the cue generation system;
selecting an alternative audio/video signal in response to receiving the cue;
transmitting the selected alternative audio/video signal to the viewer in lieu of the media provider's signal when the alternative signal is selected; and
terminating any transmission of the selected alternative audio/video signal to the viewer in response to a notification from the cue generation system when an end of the event detected, or another event is detected that requires resumption of displaying of input stream from provider, such that the media provider's audio/video signal is permitted to be transmitted to the viewer.

14. A method in accordance with claim 13, wherein the cue generation system comprises a locally based system at the location of the viewer.

15. A method in accordance with claim 13, wherein the cue generation system is installed on a server comprising one or more computing devices, and the cue received at the alternate signal selecting element is transmitted across a public data network.

16. A method in accordance with claim 15, wherein the detecting comprises one or more human operators detecting the start or end of an event.

17. A method in accordance with claim 13, further comprising gathering, categorizing and storing personal data regarding the viewer taken from the viewer's personal device or devices, and selecting one or more alternative signals based on the personal data regarding the viewer.

18. A method in accordance with claim 13, wherein the event detected is an advertisement on media provider's audio/video signal.

19. A method in accordance with claim 18, wherein the alternative audio/video signal is an alternative advertisement selected based on viewer personal data.

20. A method in accordance with claim 13, wherein the alternative signal is provided to the system from a server across a public communications network, via disc, or via other storage media.
